(19) United States
(12) Patent Application Publication
(10) Pub. No.: US 2017/0308818 A1
(43) Pub. Date: Oct. 26, 2017

(54) PAYMENT AND ORDERING SYSTEM AND APPLICATION FOR A MOBILE CLIENT

(71) Applicant: Mohammad ALMISHARI, Safat (KW)

(72) Inventor: Mohammad ALMISHARI, Safat (KW)

(21) Appl. No.: 15/138,074

(22) Filed: Apr. 25, 2016

(51) Int. Cl. G06Q 10/02; G06Q 50/12; G06Q 30/06; G06Q 30/04; G06Q 20/40; G06Q 20/32; G06Q 20/20; H04B 5/00; G06Q 20/10

(52) U.S. Cl. CPC G06Q 10/02; H04B 5/0062; G06Q 50/12; G06Q 30/0641; G06Q 30/0635; G06Q 20/102; G06Q 30/04; G06Q 20/405; G06Q 20/3278; G06Q 20/204; G06Q 30/0627

(57) ABSTRACT

The system and application for smart devices is a system that functions in conjunction with an application that operates on a handheld electronic device for handling restaurant transactions. The application allows a customer to reserve a table at a restaurant, order their food before going to the reserved table, and pay the bill at the touch of a button using their mobile phone or device. The application can also provide delivery service for food orders from restaurants/cafes and many associated functions. In addition, the system includes plastic cards with a radio frequency identification device (RFID) for each user. An RFID reader is mounted at the door of the restaurants, such that a user can automatically pay their bills upon exiting a restaurant.

### BACKGROUND OF THE INVENTION

### 1. Field of the Invention

The present invention relates to a smart phone/device application and system, and more particularly to a system that functions in conjunction with a software application provided on a handheld electronic device for facilitating restaurant ordering and payment transactions.

### 2. Description of the Related Art

Most mobile goods payment systems used for ordering restaurant food and beverages are limited, in that the system typically requires the user to first be present in the restaurant to download the menu onto their mobile client or smart phones, and pay for the goods or meal being purchased. Only under these circumstances can the user proceed with ordering and paying. The process of ordering and paying can be time consuming. Accordingly, there exist a need for a mobile payment system that does not rely on the user being located in the restaurant to download the menu and to pay for goods and/or services.

Thus, an eat and run system and application for smart devices is contemplated for facilitating faster or expedited user to restaurant/vendor transactions, thus solving the aforementioned problems is desired.

### SUMMARY OF THE INVENTION

The payment and ordering system and application (“eat and run system and application”) for smart devices is a system that functions in conjunction with an application (hereinafter, “App”) configured to operate on mobile client and/or handheld electronic device for handling restaurant transactions. The Application allows a customer to: 1) reserve a table at a restaurant; 2) order their food before going to the reserved table; and 3) pay the bill for the food or goods at the touch of a button using their mobile phone or device. The Application may also facilitate delivery service for food orders from restaurants/cafes and many associated functions. In addition, the system includes plastic cards with a radio frequency identification device (RFID) for each user. An RFID reader may be mounted approximate to the door of the restaurant, such that a user can automatically pay their bill or tab upon exiting the establishment.

These and other features of the present invention will become readily apparent upon further review of the following specification and drawings.

### BRIEF DESCRIPTION OF THE DRAWINGS

FIG. 1 is a screenshot showing category and item selection screens for the mobile payment system and application for smart devices, according to the present invention.

FIG. 2 is a screenshot showing additional category and item selection screens for the system and application for smart devices, according to the present invention.

FIG. 3 is a flow chart of a method for the system and application for smart devices, according to the present invention.

FIG. 4 is a system block diagram of the system and application for smart devices, according to the present invention.

Similar reference characters denote corresponding features consistently throughout the attached drawings.

### DETAILED DESCRIPTION OF THE PREFERRED EMBODIMENTS

The mobile payment system “eat and run system” and application (“App”) is configured for use with a mobile client or smart device. The system functions in conjunction with the “App” operates on a mobile client or handheld electronic device for handling restaurant transactions. The application allows a customer to: 1) reserve a table at a restaurant; 2) order their food before going to the reserved table; and 3) pay the bill at the touch of a button using their mobile phone or device. The application may also connect the user and restaurant to facilitate delivery service for food orders from restaurants/cafes and many associated functions. In addition, the system may include plastic cards with a radio frequency identification device (RFID) for each user. An RFID reader is mounted at the door of the restaurants, such that a user can automatically pay their bills upon exiting a restaurant.

Possible embodiments of the system are described in U.S. Pat. No. 9,117,231 B2, which is incorporated by reference in its entirety herein.

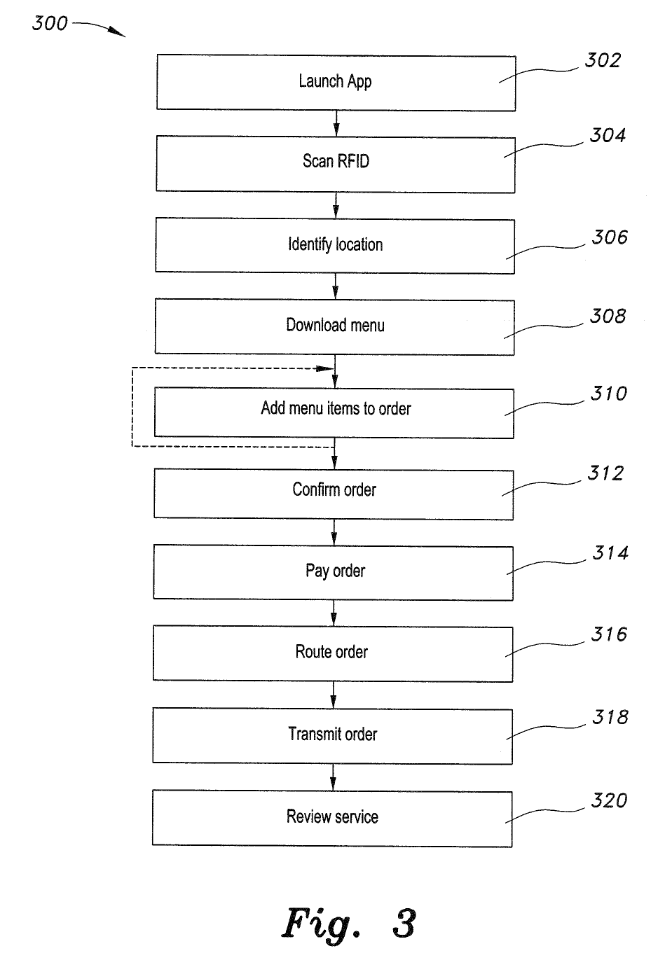

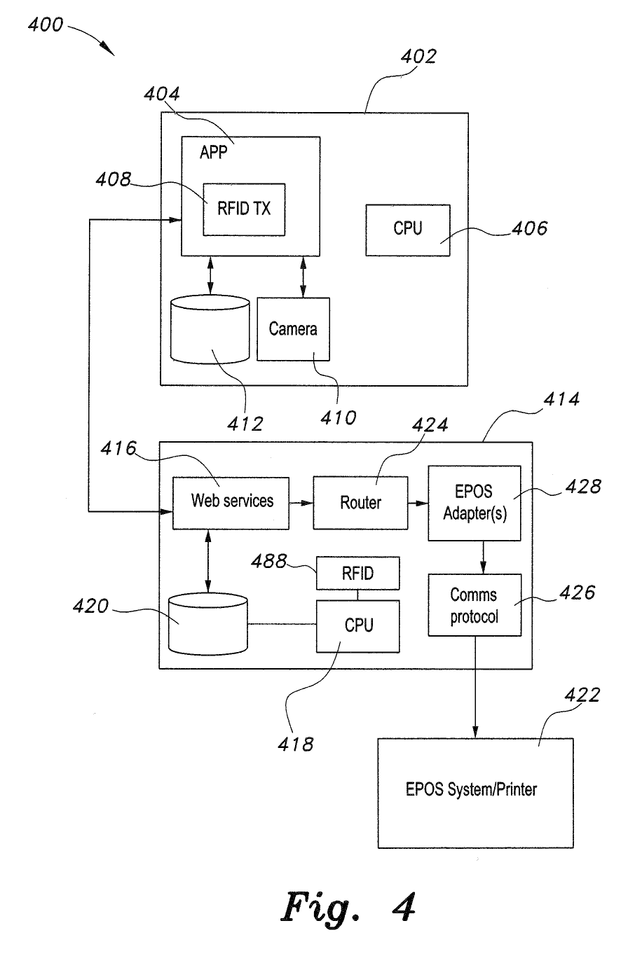

Referring now to FIG. 4, the system 400 includes a mobile client or smart phone 402 having an application (“App”) 404, a central processing unit 406 (“CPU”), an RFID code transmitter 408 and a central platform 412. The mobile client and/or smartphone 402 includes an application “App” 404 stored in the mobile clients 402 memory. The application 404 may be downloaded and installed on the smartphone 402. When the one or more sequences of machine-readable program instructions of the application 404 are loaded into the CPU 406 of the smartphone, the CPU 406 is configured to execute the program instructions of the application 404. Execution of the application's instructions and protocols assists and activates the CPU 406 to execute the steps of processing a user's purchase and payment 300 by steps 302 to 312, illustrated in FIG. 3. The RFID code transmitter 408 may be an embedded component within the application 404. The RFID code transmitter 408 and application 404 are in communication with the camera 410, and capable of accessing the camera 410 for identity verification using scanning features provided by the camera 410. The application 404 is also in communication to access the database 412. The application 404 is configured to access a central platform 414 via web services 416, wireless data transfer, Bluetooth® or other communication means, over the system 400 utilizing a router 424. This may be done using communication means that incorporate, Hypertext Transfer Protocol Secure (HTTPS), for example. The central platform 414 may also be connected to an RFID scanner 488 to confirm transaction data of the application 404. The application 404 transaction data may be used by an Electronic Point of Sale (EPOS) system 422 to complete or conduct transactions relating to the purchase of goods, such as an ordered and consumed meal by the user, for example. A RFID scanner 488 may be placed in a central location of a restaurant, like at the door of the restaurant/café, for example to sense and track the ordering process and movements of the users. For example, when a customer exits the establishment through a door, the RFID scanner 488 detects the movement of the customer, and that the user has left, and thus triggers the EPOS system 422 to perform or process a transaction to pay the restaurant. As such the payment process for the user is commenced in real-time. The central platform 414 may also have mass storage unit 420 or database capable of storing and keeping track of customers and customer related data, such as, purchased goods, their meal orders, and the restaurant meal offerings/menus, and the like. The central platform CPU 418 coordinates the processing of the transaction over the central platform 414, particularly with respect to the electronic point of sale adapters 428 via communications protocol 426 for access to the EPOS system 422. The system 400 provides the means for performing the myriad of methods described hereinafter.

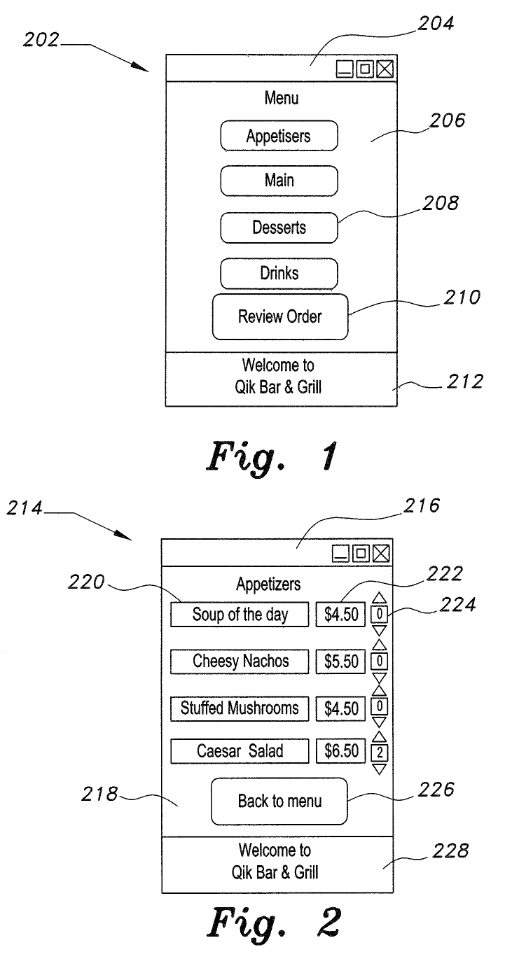

The application 404 may provide a restaurant menu selection screen 202 (shown in FIG. 1) with a navigation feature 204 and product category menu feature 206 with buttons or features for the user to select categories of items to purchase, such as appetizers, main, desserts 208 and drinks, for example. A review order button 210 is also provided by the application 404. A message feature 212 may also be provided for example for a message and/or logo of the restaurant. As shown in FIG. 2, an item selection screen 214 may include a navigation feature 216 and an item selection feature 218 with a pairs of item display fields for description 220 and price 222, each pair accompanied by a quantity control 224 for the user to input a quantity of each item for the order. In this example, the items are soup of the day 220, cheesy nachos, stuffed mushrooms or Caesar salad. A back to menu button 226 may be provided by the Application 404 to allow the user to return to the category selection screen 202. A message area 228 may be provided for example for a message and/or logo of the restaurant.

As illustrated in FIG. 3, the method 300 of performing a transaction within the system 400 includes the following steps. At step 302, the application 404 may be launched or activated. The application 404 may have been previously downloaded and installed from an application provider such as Apple®, Android®, or the like. A unique identifier for the customer may be assigned to the customer by the client 402 or by the application provider. At step 304 pre-programed code from the RFID transmitter 408 is detected and read by the RFID receiver 488 to uniquely identify the customer and other customer related characteristics, such as the customer's order, the customer's location relative to the establishment (i.e. if the customer is exiting) to uniquely identify and assign the customer's tab or bill for processing by the central platform 414 and EPOS system 422. At step 306, the user's location may be identified using navigation and co-location technology, thereby allowing the application 404 to find or display a list of restaurants, arranged in categories, such as the distance to the user's location. The user may select the establishment or restaurant he or she is at, or the application 404 may automatically assign the establishment to the user based on location data. At step 308 a restaurant menu may be downloaded, once the user or application 404 has selected the user's restaurant location from the list of restaurants. At step 310 the user interacts with the digital menu in the application 404 to select items from the menu. Items selected are added to the order. This step may be repeated numerous times by the user, as indicated by the dashed line. At step 312 the user may “checkout” or commence the payment process by reviewing and confirming the goods selected or consumed by the user, and then rendering payment. At step 314 the user may pay the service professional directly or the user may use a credit or debit card pre-saved in the Application 404 or remotely on the system 400, to pay for the order. Additional cards or payment methods may be added, as desired. It is contemplated that the payment card information may be stored in encrypted form in a local database on the client 402 or in a mobile wallet. Alternatively the payment card information may be stored centrally and accessed using the unique customer identifier. Payment details may be stored in other accounts, such as social network accounts including Facebook®, Twitter®, Google®, or the like. As such, the existing payment information may be accessed by signing in to the account. Payment systems such as Paypal® may also be used. At step 316 the restaurant identifier is used to determine and select the appropriate EPOS adapter 428 based on the EPOS system in use by the specific restaurant. The restaurant identifier is used to determine and select the appropriate communication protocol and communication network. At step 318 the correct communication protocol and authentication details are then used in order to route the order to the restaurant EPOS system 422 for printing. At step 320 the user has the ability to sign-in to their existing social network accounts and record a review of the service.

It should be understood that reservation is optional. The automatic payment for the goods or meal using the RFID identification provided by the mobile client/smart device 402 or an optional plastic card is available for the user. This is the case, whether or not the user engages the reservation option provided by the application 404. After making a reservation, the user has the option of placing their order of food any time. (Restaurants/cafes have the option of providing this service). The Customer has the option of splitting the bill with friends. For this option to work the friends must also have the application 404 installed and registered on their smart devices 402. Moreover, the user will be able to order their food through the Application 404 and have the food be delivered to a preselected location. For customer registration of the Application 404, the application 404 may provide an interface for the user to register with the system 400. For example, a first page of the application 404 may have buttons or features for a user to register. Features may include button for new users to sign up, a sign in button for previous users to sign into their accounts, a Restaurant/Café register button to activate an email address field of the operating company (“Eat & Run Company”) or provider to contact for registration. When the operating company and subscribing restaurant/café make an agreement about the commission taken by the operating company, the operating company may visit the restaurant/café to see if it fits the criteria and is suitable to be a registered provider in the system 400. If the operating company accepts the restaurant/café, the operating company will provide the restaurant/café with registration information, such as an email that contains a link and a special password that can be used only once. The restaurant/café presses on the link, fills out the special password and will then be directed to the application registration form to fill out information including but not limited to: 1) user name; 2) password: 3) name of restaurant/café; 4) name of the company that owns the restaurant/café; 5) name and telephone Number of a manger, or restaurant operator; 6) telephone number of the restaurant/café: 7) type of cuisine, social media accounts (Instagram/Twitter/Facebook account); 8) address of the restaurant/café; 9) pictures of the restaurant and meals (Maximum of 5 pictures which can be changed by restaurant any time); 10) details of the Menu; 11) bank account number required to make payment transfers; and, 12) email Address. Preferably, the registration will not complete unless all the information is provided.

When restaurant/café fills out the form, restaurant/café will press on button “Done”. If any information is not filled, a red highlight will show on any missing information. Users may select the language with which he/she wants to use the application 404.

Customer signup includes the customer filling out username and password to create an account. The customer then fills out other customer characteristics and details which may include: 1) customer first and family name; 2) mobile number; 3) email address; 4) credit card number; and, 5) expiration date, and security code. The customer may have the option of saving more than one credit/debit card and/or payment method (user can change the credit/debit card anytime). The customer also has the option of providing a fixed tip percentage or amount, chosen for restaurant payments (User chooses between 0%-30%). This percentage can be changed later if desired.

Preferably, the registration can't be completed if any of the above information is not provided. The application 404 may provide a red highlight will show on any missing information. The customer receives communication email directly and automatically after registering to confirm account sign up information and to thank the user for registering. The customer is sent a communication, such as a link to the system 400, prompting the user to activate his/her new account. The text/information in the email may be modified according to the user. Once the customer clicks on the link in the email, the customer's account becomes active. To sign in, the user enters the user's username and password.

The webpage after sign in may have an account details button on the top left corner on the home page. This button allows the user to navigate to the User's account details. Account details page may include a “reservations” button to make reservations, a “bookings” button that contains all previously booked restaurant reservations, a “payment button” to open a bill or invoice, a payment history button that navigates to all previous payments and current active bill, a payment method button that navigates to where user credit card numbers are saved, a delivery service button that navigates to a list of restaurants/cafes and cuisines to choose from, and enabling the user to choose the food order from the menus provided by the restaurants/cafes, and a settings button that navigates to where the user's details are saved, e.g., name, mobile phone, email address, fixed tip chosen, and the like.

The application 404 may present a list on the first page with all the countries that system 400 is working with. The user first chooses the country the user desires. The application then asks the user to turn on location services on their phone. The application 404 then shows a list of restaurants starting from the closest to the User's location. When the user clicks on the restaurant the application 404 provides a photographic image of the restaurant/café. The application 404 informs the user whether this is a restaurant or a café. The application 404 also provides the distance the restaurant is from the user, the rating (done by System 400 members), the restaurant address, a description of the restaurant/café, the working hours (From . . . To . . . ), the restaurant status, open or closed at the visiting time, the Cuisine (Chinese, Japanese, Lebanese . . . etc.). Through location services users can view the distance from the user location to the chosen restaurant/cafe via Google maps. The chosen restaurant/cafe page may include a “Call” button available for users to directly call the restaurant/café. Reserve, open bill, join bill, pay bill, payment history, and delivery service are other options selectable from pages in the application 404.

With respect to reservations, the application 404 provides a list of restaurants that use the operating company's (“Eat & Run”) services. Customer may view locations of the restaurants that use the services near them. Customers can view restaurant menus, reviews and photos (maximum 5 photos). Customers can reserve by group size, date, time, cuisine, distance from customer's location. The application 404 allows customers to manage reservations; cancel or change date/time/table/group size. The application 404 allows users to have the option of sending reminders or invitations to friends by entering their System 400 usernames.

The application 404 provides a reserve button or feature and allows a user to choose among options which include, for example, “location near you”, restaurant list, cuisine (i.e. Japanese, Italian . . . etc.), date, time, and group size . . . etc. The user may select details according to their needs. The application 404 provides a confirm button that may be pressed once the user finds the reservation he/she wants. The application 404 provides the user with an option of having the reservation sent to the user's reminder application. Moreover, the system 400 sends an email to the user that includes a confirmation from the restaurant through with reservation details. Preferably, the restaurants will keep the reserved table up to 15 minutes after the time is booked. After the 15 minutes period the table may be released and no longer reserved for the user. Restaurant telephone number may be provided to give the user the option of calling (in case of delay or any info needed to pass). The user may send invitations through a feature provided by the application 404 to friends or invitees by selecting the person's information from the mobile's contact list. (friends chosen must be Eat&Run members/subscribers). Invited friends get a notification about the invite and have the option of adding the reservation in their reminder list. The system 400 allows the user to send SMS automated text message to Friends who are not members of the system 400 (“Eat & Run”) to encourage them to join.

There is a button called “Bookings” in the main page where the User's confirmed reservations are listed. The system 400 allows the user to go to their saved booking and manage their bookings (Change date, time or group size according to restaurant availability or cancel the booking).

After making a reservation, the system 400 provides the user the option of placing their order of food any time before their day/time of reservation (this is optional for the restaurant/café). The system 400 allows the user to place the order either by calling the restaurant/café by phone, or the user can order by going through and choosing from the menu that the restaurant/café has provided for the application 404. If the user is late a half hour or more from time of reservation, the food ordered will be debited from the user's account.

Once User sits at his/her table, user presses on the “open bill” button in the application 404. The user tells the service professional that he/she is using the application 404, then gives the service professional his/her system username and opens a bill on his/her phone (presses on “Open Bill” button found on the chosen restaurant/café). Alternatively, when the user presses on the “Open Bill” button, a four digit number is generated and presented to the user on the screen, and the user shows that number to the service professional. The service professional records that number and the user's table number. If the user has made a reservation through the application 404, then the service professional should already have the user's username saved, and the User can simply open a bill. When the user gives his/her order, the service professional enters the order in the system 400 and the bill will directly be updated. Therefore the user can view his/her bill any time while in the restaurant. Any added orders, will be added to the same bill automatically. When the user is ready to leave, he/she can check the bill on the application 404 on her phone and simply press the button “Accept & Pay” and will be able to leave the restaurant right away.

If the user wants to split the bill with friends, the User can have the friends join the bill by pressing on the “Join bill” button (which will have them join the User's bill either by Bluetooth or WIFI) and can either split the bill evenly or each person can choose the items they want to pay for (Friends must be Eat & Run users). The user can change the percentage for the tip at any time. If user leaves without pressing the Pay button, the bill will be automatically charged within 4 hours from opening the bill. The application 404 may provide a “Payment History” button on the main page where all previous payments have been saved, and the current active bill or invoice is saved.

Step-by-step details of the system 400 operation include the fact that once the user is in a restaurant, the user checks through the application 404, with locations services on, whether the restaurant is a system 400 (“Eat & Run”) services subscriber. If restaurant is a subscriber, then the user presses selects the restaurant, linking the restaurants EPOS 422 to the user's application 404 within the system 400. The system 400 allows the user to set a limit to the maximum he/she wants to spend on this bill (from 0-1000 KD). The system 400 then provides the user a page with an “Open Bill” button. Once the user presses this button, a bill or ordering portal is opened and the time it has been opened is saved. Additionally a 4 digit number, or customer identifying code is generated for the user.

The user tells the service professional that he is using the application 404 and system 400 (“Eat & Run”) and gives the service professional his 4 digit number or a user identifying code. The service professional keeps record of the user's 4 digit number and the table number. The user gives the service professional his order. The service professional enters customer's order using a mobile device, such as, a phone or tablet (i.e., IPAD) or through the restaurant's regular computer system. Notably, connection between the user and restaurant may be made through a separate program created by the operating company (“Eat & Run”) for the subscribing restaurant to download. This program contains the complete menu and prices, and the service professional can enter the order by choosing the items one by one. Each restaurant is responsible for updating their menu and prices in the system 400.

Alternatively, the service professional enters the order in a program that is compatible with the restaurant's computer system and with the system 400. The user gets instant and automatic updates of his order and bill from the restaurant to the application 404 on his phone 402. Once the user is done, the user checks the bill and the application 404 presents an “Accept & Pay” option or a “Split Bill” option. If user chooses to just Accept & Pay, he can simply press that button and leave the restaurant. If the user chooses to split the bill, the user presses “join bill” button, then the system 400 allows the user to have his/her friends join the bill either by Bluetooth or Wi-Fi. The user can choose the friends that will split the bill by going through the contact list and clicking on the friends (the system 400 “Eat & Run” must be able to access the user's contact list and filter only the friends who are Eat & Run members). All friends splitting the bill must be system 400 (“Eat & Run”) members. The user will then be directed to another page where the user can choose to split bill evenly or choose items to split. If user chooses to split the bill evenly between friends, the user simply presses join bill button and leaves. If user wants to choose which items to pay for, user then presses that button which allows the user and each of the friends to choose which items they want to pay for. Once the user and friends are done choosing, then the user can press Accept & Pay and leave. Users can then rate the application 404 and restaurants and cafes and write their comments that will be sent to the customer service team. All the above can be seen by the users in the application. User can change the percentage of the tip whenever they want.

With respect to a delivery service category of the application 404, the user presses on the “Delivery Service” category on the homepage. For first time users, the user will be asked to fill out the default address that he/she will usually want their food to be delivered. The user has the option of adding multiple addresses. All the addresses will be saved to a category called “Addresses”. The user may be directed to a page with buttons allowing the user to “Search by Cuisine”, “Search by Restaurant/café name”, “Address Area”, “Re-order”, and “Rate past orders”. When user presses on “Search by Cuisine”, restaurant list will be refined according to the cuisine the user chooses. The user has then the ability to look through them all and choose freely. When the user presses on “Search by Restaurant/café name”, a list of all the restaurants registered with a delivery service will be provided. The user has then the ability to look through them all and choose freely. When choosing a restaurant/cafe, the application 404 may provide a page showing all the information about that restaurant/café. The information provided may include an average rating by users, open or closed status, cuisine of the restaurant/café, working hours, the time needed from order to delivery, minimum order charge, delivery charge, and types of payment accepted. When user presses on “Address Area”, User must choose the Area where he/she wants the food to be delivered, and so a list of restaurants/café will be provided that are able to deliver to that area. Whichever way the user chooses to start, after choosing the restaurant/café, user then is provided with a menu of the restaurant/café and can choose which food items he/she wants to add to the cart. After choosing all the items and adding each to the cart, the User can then press on a button called “Go to cart” There the user is able to check on the things he/she ordered, and the total amount to be paid including delivery service. The user is able to edit the cart by pressing on a “Edit” button on the top of the page. Near each item a “Remove” button is available to remove the item. Also there is a column called “Quantity”, and near each food item a number is written that shows the quantity of that food item that has been added to the cart. A “+” and a “−” button are near that number, so the user can add or decrease the quantity of that food item ordered. The user then can choose the time they want the food to be delivered. They will be provided with a list of time food can be delivered for the next 24 hours and they can choose the time they want. Also the default address provided will be shown as the address for delivery. If the user wants to edit the address they can do so by clicking on the “Edit” button. There the user can change the details of the address. If the user wants the food to be delivered to a completely different address, the user can press on a button “New Address” and fill out the details of the new address and save it. Once the order and address have been revised and finalized, the user can press on a “Deliver” button. The user will be directed to a page to choose the method of payment desired. The options for payment are: Kuwaiti Banking Network (KNET), Visa/Mastercard/Amex etc, or cash on delivery. If the user presses on KNET she will be directed to the KNET payment site, where he/she will fill the required information and pay and will be redirected back to operating company's page to a page that will show the user the confirmation of the order and the order number. If User presses on Visa/MasterCard etc, user can easily pay using one of the cards he/she has saved in his/her account. User will then be provided with the confirmation of the delivery service and the order number.

If user chooses “cash on delivery”, user will directly be provided with the confirmation of the delivery service and the order number.

If the user presses on “Re-order”, user has the option of placing the same order he/she has made previously. A list of his/her past ten orders is shown. The user can choose one of them, to save time and get what he/she wants faster. The user is then transferred to the payment page where he/she can choose the method of payment as above. If the user presses on “Rate my orders”, user gets a list of the past 10 orders he/she has made and a list with numbers from “1” to “5” is provided for the user to rate the delivery service of that restaurant. “1” is the lowest rate and “5” is the highest rate. That rate will be added to the restaurant/cafe, and the average will be shown next to each restaurant for users to see, to help them choose the desired restaurant/cafe.

With respect to agreement details, credit card details are saved safely in the phone with military grade encryption. The system 400 charges the restaurants its commission on each payment done through the application. (the commission can be changed in the future for any restaurant or all restaurant/café). Restaurant/café and user sign up for an annual registration with system 400 (Registration fee may be added in the future). Also the system 400 may provide the option to be able to charge the users in the future to register with the system 400 “Eat &Run”. The system 400 “Eat & Run” allows an administrator to view user history of payments for statistical study purposes. The information that can be viewed includes username, name of restaurants, total money the system 400 earned from the payments of this client with one or all the restaurants/cafes, Total money the system 400 gained from any restaurant chosen, and times and dates of all payments.

The application 404 preferably has a button that allows the team to view calculated statistics such as, for example, which restaurant is making the most payments through the application 404 per week. That restaurant will get a free advertisement space on the application for a week, the application will do this automatically and will send email to eat & run company.

Registered restaurants that have many branches, can have one system 400 account, and sub-accounts for each branch that all fall under the umbrella of the main restaurant account. That way all information for this restaurant is neatly and securely saved under one main account. The application 404 preferably has the flexibility of adding advertisements on any place on the application pages (especially on the first page and the lower 10% part of the inner pages, for one or more advertisements which can change automatically by the seconds or minutes according to our desire). Any new registered restaurant will get a space for advertisement in the inner pages of the application for a week, free of charge, the application will do this automatically and will send email to eat & run company. Operating company must have the accessibility to email any/all Users in any/all countries at any time. Moreover, the application 404 preferably has the ability to know the numbers of users, restaurants/cafes in any/all countries, the ability to turn ON/OFF, ANY/ALL the services such as, for example, PAY, RESERVATION, RESERVATION AND ORDER, DELIVERY SERVICE, any time.

Additionally, the application 404 preferably has the ability to know the number of users visiting each restaurant/café which can be shown near the rating of restaurant/café, and the ability to know the quantity and the amount of commissions taken from restaurants/cafes by eat and run company (as the commissions is not the same for all restaurants/cafes). The commission is fixed in general to all restaurants/cafes and it can be changed to any/all restaurants/cafes at any time. Operating company cannot see the details of credit cards of the users and the accounts of the restaurants/cafes as it is saved in the system 400, only the users and restaurants/cafes can reach the accounts. If a problem arises in the software of the application, operating company has the ability to stop the software system from working with all the users. An automated notification is sent to all users apologizing for any inconvenience caused and explaining that a system error has occurred and that customer service team is working hard to fix it quick.

A main page of the application 404 may include buttons or fields indicating the number of users that are registered with the operating company's service (“Eat&Run”), the number of restaurants that are registered with the operating company, and the number of cafes that are registered with the operating company. This data maybe updated automatically (these three buttons can be turned on/off by eat and run company). The application 404 may check to see if the user's chosen credit card is expired, and if the user's account has enough money to pay his bill. The application 404 may also check to see if there's another credit/debit card available for payment, and if so, the application 404 will capture it automatically. If the second card or payment method has the same problem, a 4 digit number will not be generated when the user attempts to open up a bill, and also the user will be prohibited from making any reservation. Accordingly, the application 404 sends a notification for the user and to restaurant if the credit card is expired and if the account is not sufficient to pay the bill. The service professional can therefore stop the order. The user then has the option of using another saved credit card.

Preferably, the system 400 has features that provides notification of restaurant/café promotions for the users. Users may be connected to the restaurant/café via social media accounts such as instagram, twitter, facebook accounts, through the application 404. A customer service email may be provided for the subscribing users and restaurants/cafes. The Application 404 may create a page that displays the operating company's patent information with the US and European Union and GCC. “Eat & Run” operating company has the rights to cancel the contract with any registered user or restaurant/café if they are not being cooperative. After the user checks his/her bill and presses on the button “Accept & Pay” the system 400 will automatically deduct the eat &run company commission from the total amount paid by the user. This commission will automatically be transferred to the operating company account and a receipt of the commission will be sent by email to the operating company. Additionally, the rest of the meal payment will be transferred to the restaurant/café account. A receipt of this amount (which is the amount paid by user minus the operating company's commission) will be sent by email to the restaurant/café. The system 400 will also include the ability to know which restaurants/cafes have not paid their commission. The application 404 and system 400 described herein provides for the user the ability to reserve a table and order food before going to a reserved table and pay the bill for a restaurant/café, and provides delivery service for food orders from restaurants and cafes.

It is to be understood that the present invention is not limited to the embodiments described above, but encompasses any and all embodiments within the scope of the following claims.

1. A system for interfacing a customer and a restaurant by circuitry connected between a customer device and a restaurant device via a network, comprising:
an RFID transmitter in possession of the customer;
an RFID receiver mounted at an entry point of the restaurant;
a central platform in operable communication with the RFID receiver, the central platform being adapted for communication with the RFID transmitter in the possession of the customer, wherein the central platform establishes a predetermined distance of operable communication between the RFID transmitter and the RFID receiver;
a mobile electronic device in possession of the customer, the mobile electronic device being comprised of mass storage, a camera, and a processor; and
a software application running on the mobile electronic device's processor and in communication with the circuitry, the RED transmitter being in communication with the application, the circuitry configured to at least:
i) reserve a table at the restaurant;
ii) display the restaurant menu selection screen on the customer device;
iii) allow the customer to select categories of food from the menu selection screen;
iv) allow the customer to review the user's food category selection;
v) allow the customer to select specific items based on the customer's food category selection;
vi) allow the customer to order the selected specific items;
vii) allow the customer to automatically pay the full amount of a bill for the selected specific items with no intervention from restaurant personnel;
viii) splitting the bill with persons designated by the user;
ix) order the selected specific items for delivery to the customer at a customer specified location away from the restaurant;
x) register the customer with an account for authorized use of the system; and
xi) allow the customer to leave the predetermined distance of operable communication without paying and to thereafter automatically pay the bill without customer intervention;
an Electronic Point of Sale (EPOS) system for processing a payment made by the user, the payment being in exchange for food items/services offered by the restaurant;
an Electronic Point of Sale (EPOS) adapter included as part of the central platform;
a communications protocol included as part of the central platform, the communications protocol being in operable communication with the EPOS adapter;
means for sending to the EPOS system, via the EPOS adapter, information about the user's payment, the information being received by the RFID receiver as transmitted by the RFID transmitter,
wherein the EPOS system automatically processes the user's payment for user selected food items and services with no intervention from restaurant personnel.

2-5. (canceled)

6. The system for interfacing a customer and a restaurant according to claim 1, further comprising circuitry to provide a customer selectable language of communication for the software application.

7. The system for interfacing a customer and a restaurant according to claim 1, further comprising circuitry to provide a customer selectable tip percentage chosen for restaurant payments.

8. (canceled)

9. The system for interfacing a customer and a restaurant according to claim 1, further comprising circuitry to:
display to the customer a list of all countries in which the software application will function;
allow the customer to select a country of interest from the countries list; and
display to the customer a list of restaurants compatible with use of the software application, the restaurants list being ordered by proximity to the user's location.

10. The system for interfacing a customer and a restaurant according to claim 1, further comprising circuitry to:
allow the customer to select a restaurant from the list of restaurants;
present to the customer a photographic image of the restaurant; and
inform the customer whether the restaurant is a café.

11-20. (canceled)
